(19) United States
(12) Patent Application Publication
(10) Pub. No.: US 2020/0179847 A1
(43) Pub. Date: Jun. 11, 2020

(54) Enhanced Surface Area Dependent Functional Material from Combinational Manufacture with Industrial Hemp for Removing Lithium and Other Constituents from Brine

(71) Applicants: Marc Privitera, Walnut Creek, CA (US); Christina Metz Borgese, San Ramon, CA (US)

(72) Inventors: Marc Privitera, Walnut Creek, CA (US); Christina Metz Borgese, San Ramon, CA (US)

(21) Appl. No.: 16/212,848

(22) Filed: Dec. 7, 2018

(51) Int. Cl. B01D 39/04; B01D 46/00; B01D 39/08; B01D 39/18; C01D 15/02

(52) U.S. Cl. CPC B01D 39/04; B01D 46/0036; C01D 15/02; B01D 39/18; B01D 39/083

(57) ABSTRACT

A material modified with cannabis, possibly partially oxidized, dissolved and reprecipitated, or in conjunction with some physical arrangement into a form with another material that can be applied to separate lithium and other dissolved constituents from brine.

Provisional Patent Applications 62/708,673 and 62/708,677 are both incorporated in this application in their entirety. The earliest of the priority dates of the provisional applications are claimed.

### SUMMARY

Cannabis is grown and harvested as a multi-component field crop. Cannabis with a tetrahydrocannabinol (THC) concentration of less than 0.3 wt % is known as industrial hemp. The significant parts of the plant can be divided into, hurd, fiber, seed and flower. Each of these significant plant parts have different economic pathways for market products which correspondingly require the specific application of chemical and mechanical processing techniques in order to extract, separate and refine the economic constituents of the plant.

Lithium is used for energy storage. Various sorbents are currently used to remove lithium compounds from lithium containing brine. The simplified mechanism of extraction is through size exclusion which requires the available molecular extraction sites to be available to the lithium. High surface area is a desired property of these various sorbents. Most of the sorbents are formed from alumina, silica or zeolites or various combinations of each.

The cannabis plant offers increased surface area functionality for chemical engineering manufacturing not yet available from traditional materials. The fiber and hurd have shown history of high surface area both in native form and after carbonization. Many functional materials depend upon specific surface interactions between the functional active in the material and the targeted material in the system. The ability to combine the cannabis material with other functional materials enables the creation of more active sites in the combined material thus enhancing the functional materials performance.

### USE

Combinational materials modified with cannabis, whether partially oxidized, dissolved and reprecipitated, or in conjunction with some physical arrangement into a form with another material can be applied to many chemical and physical unit operations well practiced in the industry. The new functionality offered from the cannabis material expands the novel uses and unique functionality of distillation, sorbents, packed bed columns, filtration, solid liquid separation, reactive distillation and other unit operations.

### DESCRIPTION OF THE INVENTION

A material in the form of a particle, fiber or block consisting of constituents from cannabis indica and cannabis sativa, but primarily sativa, extracted, manipulated and/or assembled through a series of operations to produce a material that is a base material of composition that enables the conversion to a product material that can perform various functions. One common similar example used in industry by those skilled in the art is carbon from coconut husks. The carbon base material from coconut husks enables the creation of a particle that performs the operation of selectively absorbing and separating various constituents from gases and liquids. The material of this invention may be in combination with a suitable substrate. Unique to the cannabis plant, the material of this invention material may be carbonized or used as manipulated from field processing as harvested plant stock formed into the useful material. The plant material could be combined with other materials for functional specificity. These could include an alumina, silica, zeolite, or carbon itself from hemp. These same combinations could be made with the industrial hemp material partially carbonized prior to combination with the functional material. The carbon from hemp could be the base functional material itself. The material from cannabis described in this invention creates high surface area exchange sites enabling and enhancing the combinational functionality.

The assembly of the material of this invention can includes techniques in a specific order including charring or partial oxidation, torrification, carbonization, compaction, agglomeration, sizing and wash loading. Charing and torrification is the conversion of the material to carbon without completely oxidizing the material to CO2. Compaction is the compression to change the density of the material. Agglomeration creates larger particles from the smaller particles which could include compaction, but also includes binding and mixing. Sizing is the separation of the particles into different material size ranges. Wash loading is a series of unit operations where the substrate material is heated and then exposed to various solutions in a particular order. The solutions may be in the solid, liquid or gas phase. The wash solutions may contain varying levels of constituents. The functionality of the product material is dependent upon controlling the process parameters during process operations, controlling concentration of constituent solution which is exposed to the substrate, and the final treatment of the material to open and expose the high surface area cavities. Steam activation could be one possible method. Steam activation is the heating of the material in the presence of water and or steam to high temperatures where the conversion and release of the steam opens the structure of the material. Other methods include heat and pressure control using various media or no media at all. Exposure time of the solution also determines the functionality of the final product. The wash loading and or steam exposure process activates the material. The sequence of operations could include the specific cycling of the pH and the specific cycling of the exposure to steam, pH cycling may or may not be included. The wash loaded, and exposed substrate is adjusted to a pH that enables the highest performance of the material. The performance of the material being the amount of target constituent retained and the capacity of the carbon or carbon/substrate mix to hold the target constituent. The rate of removal and the residence time for stripping exposure for regeneration are also important performance parameters. The substrates upon which the functionality of the material is built can be of varying particle sizes. The most applicable particles are in the range of common powders. The particle size determines the surface area and the ultimate final product particle efficacy. Efficacy being defined as the performance of the material and the strength of the particle for durability in use. Hemp has been shown to have favorable surface area to weight ratios in such applications.

Industrial hemp processing coupled with field agricultural grow conditions will produce materials uniquely available for various novel applications.

When a cultivar planted and grown for fiber is given a high amount of natural nitrogen, usually in the form of manure incorporated into the soil via tillage methods, the stalks of the plant grow significantly larger in diameter and produce a greater amount of the inner hurd material. The hurd is a cellulosic material and if the grow techniques are coupled with certain processing steps a high surface area carbon unique for energy storage devices or chemical separation is created.

The high natural nitrogen field conditions must be coupled with management of the field such that good drainage is present and the cold temperatures outside the normal growing window are avoided. The usual chemical nitrogen application for industrial hemp is above 150 lbs/acre. The usual growing season runs from mid-May to mid-October. Industrial hemp similarly grown, but without the use of natural nitrogen sources did not show the same extent of large diameter hurd production. The use of manure as the nitrogen source is critical to the formation of the hurd material for the use in final products.

Once harvested, the hurd is usually separated from the outer bast long staple fibers of the plant by a process of decortication. The process crimps the stalk such that the inner hurd cracks and the outer bast fiber peels away from the cracked inner hurd. This process is cumbersome and expensive and is usually associated with the preparation of the outer bast fiber for further refining into staple fiber feedstock for either papermaking or textile applications. In this invention, the separation of the hurd from the bast prior to further refinement is not necessary, since the composition of the material can be from both the hurd and the fiber. This reduces the complexity and the cost of the usual processing steps associated with previous applications of the field material to various uses.

The stalk is made up of both bast and hurd. It is harvested from the field using one of many harvest techniques. It can be delivered as a bale, as a loose stalk, or chopped into particles usually associated with forage operations. The material can be placed in covered storage which may consist commonly of a barn but could include a covered bunk or a covered stack which have become common over the last ten years in agriculture displacing the previously common silo storage techniques. The mold and mildews associated with the loss of bunk storage are not a concern with this material's coupling with the processing techniques to produce the high surface area carbon base for application to energy storage devices or chemical separation systems.

Hemp straw is milled using appropriate devices and size classification equipment. The hurd to fiber ratio is variable and the particle size of both can be the result of the as milled discharge of the equipment.

The milled straw is packed in a carbonization reactor. This reactor can be a volumetric container that has the ability to change the position of the material in the container either by agitation, or by tumbling the material by rotating the container itself.

The oxygen ratio to other gasses must be controlled in the container. The ratio is controlled by the natural displacement of the carbonization gasses by placing a loose lid on the container and allowing the gasses to escape while displacing any oxygen from the atmosphere that would be trying to enter the container. A closed vessel with appropriate pressure relief protection would also be appropriate, but not necessary. Inert gasses may also be used to displace oxygen and prevent its entry into the container.

The heated container's ability to modify the amount of oxygen (or air) can be accomplished using many methods including the displacement of fresh oxygen by the discharging gases from the solid mass as it is heated in the container by using careful control of the container temperature.

A heat source is applied to the container. An open fire under the container is appropriate as is also many controlled temperature fired heaters. The material in the container must reach between 400 F and 600 F. This is can be monitored by the color and volume of smoke being released from the carbonizing material. As the material carbonizes, steam is first released from the reacting mass. After the steam release is complete, the higher boiling point temperature organics begin to gasify. If oxygen is introduced, certain components of the charge mass will oxidize. The control of this addition is to balance the heat needed to keep the carbonization continuing and the consumption of the carbon itself.

Once the mass is reduced to a black carbonaceous mass combined with the non-oxidizing ash, water is sprayed on the reacting mass. The water, now steam in the container mass, begins the conversion of the amorphous carbon to the more structured high surface area carbon.

As the steam is formed, the reaction mass cools and the heat source is either immediately removed or allowed to anneal by stopping the continued addition of fuel.

The carbonized hemp straw is harvested and used as a feedstock for products using methods described below.

Many sources of applied heat may be used including many open flame techniques. The material in the container is allowed to pyrolyze and to some controlled extent oxidize until the pile of heated material reduces in volume as the water and a portion of the fixed carbon is converted into to gases and escapes from the container through a controlled method. Control of this conversion is accomplished by monitoring the temperature and by observing the behavior of the escaping gases. Observation and control of the remaining reduced volume mass is also critical as the operation must allow for some simple mixing of the material through the use of a mixing implement or by use of a rotary motion of the container itself thus tumbling the mass of converted stalk material.

The temperature profile of the heated container and the temperature profile of the converting material follows a defined progression throughout the reaction. At between 200 F and 240 F a defined white gray gas is released from the material. This continues for a time proportional to the mass of the initial charge. An example might be for 20 lbs of charge, the reaction discharge gas at this phase continues for 4 to 6 minutes.

After this reaction gas release, the material volume is reduced between 20% to 90% by volume dependent upon the packing density of the initial charge. An example might be a charge between 2 lb/ft 3 and 10 lbs/ft 3. These are dependent upon specific packing techniques.

The reaction continues until a range of 400 F to 600 F is reached. At this temperature, the initially reacted material, secondarily forms the desired carbon.

The hold time at this temperature is dependent upon the particle size of the material as a result of the volume reduction and the amount of shear imparted on the material either by the particle to particle shear action of the tumbler or the equipment surface to material shear imparted by the mixing devices employed. Low shear tumbling requires more hold time. High shear requires less hold time. A typical range of values may be expressed as an example of 2 minutes hold time for a shear rate determined by the speed of the agitator inserted which may be in the range of 10 to 60 revolutions per minute (rpm). A low shear example may require 10 minutes hold time coupled with the tumbling shear as described by the speed of the container on the tumbler between 1 and 5 rpm.

The material is allowed to cool and is removed from the reactor.

The process described above is well known and has been practiced since antiquity with many cellulosic materials, the unique aspect lies in the application to cannabis combined with the control of the parameters to produce the carbon base that enables the functionality desired in the final product.

The method of growing the hemp described also contributes to the final properties in such that the short growth cycle and increased mass yield of the hurd through the use of high nitrogen sources in the field creates a wider and less dense cellulosic structure when compared to other cellulosic feedstocks that are used for carbon conversion.

The material is transferred to a second reactor where the chemical process sequence is initiated.

The material is mixed with mineral acid or with other suitable activating chemicals. These may be many of different types as the critical element is the hydronium ion interacting with the non-carbonaceous material still present in the reacted mass. The acid concentration relative to the mass of the carbonized material may be between 1 wt % to 50 wt %. The concentration is inversely proportional to the hold time required when the similar samples are subjected to similar acid reactor shear rates during this phase of the process.

After acid mix, the material is washed and the wash water and acid is recovered for use in future reactions. The material can now be subjected to additional functional combinational reactions where certain activating chemicals are introduced in a slurry mix and the combination is heated and mixed for various durations at different shear rates to enable the incorporation of the functional active into the hemp material matrix. These may be many materials each with different desired functional properties.

The material could be now subjected to steam heating in a third reactor to expand the particle surface area. The steam heating continues for a hold time proportional to the mass of the charge to the steam reactor. A typical range may be 5 minutes per lb of charge, however, as the charge mass increases, the steam rate can also increase reducing the required hold time. These may be relative to a 20% reduction in this required ratio for each 5 lb increase in the charge mass coupled with the same relative increase in the steam rate as a result of the ratio reduction requirement.

The material is then placed in a fourth reactor and is heated to between 500F and 1000 F. This reaction must take place in a low oxygen environment and the amount of oxygen allowed present is used to consume part of the mass for conversion to heat for efficiency in the use of fuel sources for the heating requirement. Many possible scenarios exist. To increase product yield, then lower oxygen is present with additional external heat. To reduce fuel costs, then more oxygen is present thus requiring less external heat, but at the expense of high surface area carbon yield.

Once reacted, the material is ground to various particle sizes. The particle size is specific to the application to an energy storage device or a chemical separation system. The use in energy storage devices requires smaller particle size. The use in a chemical separation system requires a larger particle size.

Batteries and supercapacitors use carbon for various components making up the assembly. Hemp carbon has shown superior functional performance when activated by various methods and formed into the appropriate geometric assembly. Taking the carbonized straw as the feedstock, first it must be ground into a small particle size. This is completed using many methods including hammer mills, rotary grinders, and other milling devices. This initial grind should be in the 100 micron range with a wide standard deviation, possibly as great as 1000 microns. The milled carbonized straw is combined with either mineral acids, caustics, or neutral solutions and is agitated using high shear devices set for various shear rates for various lengths of time. After about 12 hours of mixing a 2.5 gallon charge at a shaft rate of 100 rpm of a 10% solution of carbon coupled with a 10% solution of activating chemical, the material is filtered and dried. The various parameters of the process are outlined in the table below. Many combinations exist that will yield similar successful results.

In addition to energy storage devices, the material removes and holds targeted constituent from various fluid streams. Fluids can be liquids or gasses. To integrate this functionality into a chemical operation, the material produced is placed in a column. The material configured in the column has an experimentally determined capacity. The capacity is a measure of the amount of the targeted constituent that can be removed from the gas or liquid stream before the sorbent is required to be regenerated. The capacity is dependent upon the concentration and type of species being removed from either the gas or liquid stream. The capacity is also dependent upon the details of the process used to form the material. The process is controlled by varying the temperature, concentration and exposure time of the substrate material. The mixing shear rate profile used during the production of the material in the wash loading process described above, and the steam activation procedure also determine the ultimate product functionality. The material may or may not be heat treated either prior to or after the loading of the lanthanide constituent or the pH cycling of the material making process. The material can be in the form of a loose bed of particles, a solid porous structure, a fiber, a block, an agglomerate bound so that the agglomerate formula, form and shape does not interfere with the particle functionality. The material performance metrics for the system include capacity and removal efficiency. Capacities are the mass of material removed divided by the volume of the material in the units of grams/liter. A physical performance parameter includes the surface area to weight ratio of the carbon and carbon blends made from hemp. The removal efficiencies are the mass of the targeted constituent removed divided by total mass of flow in units of gram/gram. The material performance depends upon the conditions of the system including mean particle size, temperature, flow rate and pressure drop. The material performance is also a function of the regeneration procedure and the number of regeneration cycles completed of the material in the system.

The material is produced in mixing systems common to the chemical industry including batch tanks, columns, and continuous mixed reactors of various configurations.

The high surface area carbon has many industrial uses as a component of other common carbon containing assembly. One of current interest is the use of this invention in the creation of an anode or as an electrode or as a collector for an energy storage device. Common embodiments of this use is in a battery, which would combinationally use an appropriate cathode, separator and electrolyte with the high surface area carbon, or a second embodiment could be in the use of the high surface area carbon as a collector assembly for a capacitor or super capacitor as they are becoming known as the storage capacity of the assemblies increase. The industrial hemp high surface area carbon has more surface area than traditional graphite carbon and can approach the physical limits of the exfoliated graphene layers of which graphite particles are comprised. The industrial hemp derived surface area carbon lends its high surface area to the very tough and low density hurd core and bast fiber that makes up the plant. When these materials are carbonized as described above in this invention, the high surface area carbon is formed and is applicable to the listed uses.

Another embodiment of this example using the material in a native state thus not carbonized as described above would be in other sorbent required applications. In equine bedding high absorbent properties are desired, in a playground bark application, high durability is desired. With the ability of the processes material to be tuned from processing to produce functional properties for either application, this invention makes use of the particle size distributions and the final finishing of the surface to yield the desired properties for the application. High absorption can be obtained by having a wider particle size distribution but tending to be larger sized to prevent the formation of dust. A washing and cleaning finish using water and steam with the opening of the interstitial spaces of the material allows the material finish to perform as desired. For the playground bark application, a larger average particle size distribution with a tighter standard deviation in combination with no steam exfoliation of the surface interstitial spaces is desired to keep the bark application from becoming too friable in its desired durable application.

This same well known balance between surface area (absorbency) and strength (durability as measured by attrition resistance) exists in the applications described in this invention for both energy storage devices and chemical separations. The material must have a high surface area to allow the functional active to be presented to the target material but the particle must be strong enough to resist the dynamics of the use of the material in an application. The battery components must hold together geometrically and similarly the chemical sorbent must not degrade to render the system inoperable due to particle clogging of the free flow path as indicated by increasing pressures in the system.

This invention describes each step in the processing of the cannabis from field stock receipt in the context of the following measurable parameters:

1. moisture, the weight percentage of water in the total mass of the plant,

2. particle size, the maximum dimension of the particle measured by the collection of particles as they pass through a series of calibrated sized screens

3. temperature

4. processing pressure

5. concentrations, this measurement is a family of measurements that relates the mass ratio of one constituent to another or the individual constituent to the total mass in the specific sample from the specific sample area of the process flow

6. shear rate, this is the mechanical energy that is imparted on the particles, liquids, and gasses that exist in different concentrations and physical forms throughout the process equipment

7.viscosity, the physical separation and purification of the various constituents is dependent upon the flow properties of the material. Viscosity specific to the point in the process at which it is sampled for measurement must take into consideration the more complex aspect of incorporating the relationship of the viscosity to shear rate, this could be better defined as rheology, however the viscosity is the controlling measurement

8. pH, ORP, O2 and other analytically derived specific constituent measurements, in these parameters, the unique processing of each target may be affected by the ratios, of each of these measurable parameters in combination with the concentration of the target constituents

The invention makes use of the specific combination of the following equipment and unit operation systems controlling the listed parameters above to deliver the product from the characterized feedstock. The combinations are unique and can specifically deliver the performance parameters required to enable economic production of the material. The order of operations in combination with the controlled parameters is unique and novel and required the application of a progressive scale up, or increase in the size of the equipment while holding certain ratios of the control parameters constant so that a predictable result can occur independent of the size or scale of the system.

1. Material collection

2. Material physical separation and trimming

3. Material drying

4. Material grinding and milling

5. Slurry making

6. Reaction

7. Distillation

8. Filtration

9. Centrifugation

10. Particle Finishing

11. Classifying

12. Packaging

A current challenge to cannabis operations is handling of the material in its solid form. As the plant is harvested, it can be presented in different physical forms from the field: grain (mostly male plant seeds), flowers (primarily female plant material), or stalks. Grain will be spherical geometrically and of different hardness. The grain collects and flows as a solid. The flowers are soft leafy solids with low density and interlocking surfaces. The stalks in their field form are hard core structures with leaves and fibers attached to some extent. Each form has different constituents of economic interest, but all forms share the need to separate these constituents through a series of unit operations that require the material mass to be transported from operation to operation. This invention captures the needed parameters from the transport conversion of the form of the material defining the possible limits to which each transport conversion can be successful. A typical example would be as follows. The grain must be dried such that the bulk moisture of the grain mass is no greater than 10 wt % water content or the grain will become sticky on its surface and will agglomerate creating plugs and slag in the needed solids flow stream. The handling of the material requires the specification of moisture, particle size and composition in order to define a successful transport mechanism. This invention could use slurry transport where there the solid material is dispersed in a continuous phase material which can be either a liquid, gas or even some types of solids. The concentration and pressure of the continuous phase becomes part of the defined parameter set for transport. An example of the solid continuous phase would be the blending of the cannabis material with a carrier solid like zeolite, bentonite, silica or another solid particle that is known for its agglomeration properties. The unique and novel aspect of this invention is the scale up process required to insure success. Whereas the particle and slurry properties can be determined on a bench scale, the rigorous application of geometric and dynamic ratios to insure success at the larger scale is required. The concentration and physical make up of the materials at the bench scale will need to be modified to demonstrate the same transport properties at the larger scale.

The various functional operations for cannabis described above can use functional particles in some form. Functional particles can be packing for the distillation, sorbent for the columns, integrated into fibers and membranes for the membranes separations. Cannabis char, whether made from indica or sativa, has significant absorbency and species retention power. This is similar to wood and other biomass char however, the cannabis char shows a propensity to behave like inorganic sorbents which have a different set of functional properties available to not only the cannabis slurries described in the functional use of the separation operations describes, but also in functional purification of other slurry and clear liquid streams. For example fatty acid methyl ester, commonly known as biodiesel, has a processing sequence that makes sulfur and residual glycerin removal difficult. Many functional particles have been used to improve these separations. Cannabis char has a greater affinity for species like sulfur and if processed in a manner consistent with the scale up and methods and form described in the unit operations above with careful control of the parameters used to define the process parameters that creates the functional composition of matter. Another example is the removal of heavy metals from brines. In the current economy, lithium is becoming short supply. Lithium containing brines are the most economical feedstock for lithium species, however many resources are hindered by the presence of heavy metal constituents rendering the lithium recovery expensive and hazardous. Cannabis char has shown an affinity for heavy metals to a greater extent than the existing sorbent technology. Using the scale up method and parameter definitions presented in this invention, the cannabis char can be applied to remove heavy metals from the lithium containing brine thus reducing the extraction difficulty and presenting a novel, useful and unique functional composition of matter. A third example would be the incorporation of the cannabis char into a polymer matrix to allow the formation of fibers, membranes to insert into existing physical fiber and membrane separation systems in order to expand the functional separations of these existing devices in a novel and unique way. Arsenic is a concern in drinking water. Cannabis char can be incorporated into existing systems to capture arsenic from the continuous stream. A fourth example is the use of cannabis char either as a particle or in conjunction with organic or inorganic co-species to be used in filtration devices of the industry. The cannabis char can be used where granulated activated carbon is currently used. Commonly carbon is mixed into a slurry or solution and then settled and filtered using the many different devices available for solid liquid separation.

A unique aspect of this invention is the mobile application of the various unit operations arranged in such a way to enable the custom processing of the various field harvest. In the more common reduction to practice, the unit operations are built as part of a specific system applied to the local conditions of the operation. This invention takes the multiple unit operations described and defines them in terms of the metrics and parameters specified and combines them to produce the needed system performance and conversions.

The arrangement of the unit operations can be specifically combined to produce the desired results based upon the parameters presented. For example if the product desired has a particle size range of 150 microns to 250 microns as determined by the material balance on a mesh screen stack (passing 60 mesh, retained on 80 mesh) this particle size determines an amount of surface area on the particles of the material that influences the downstream unit operations. By determining the performance of the extraction, separation or distillation based on the particle size distribution defined, the arrangement of the downstream operations can be tailored to specifically apply the equipment in the unit. This is common in stationary designs, and can be applied to a mobile or “plug and play” system, but the predictable performance of the system is determined with this invention's method of parameter definition and scale up modeling applied to the cannabis materials which are unique in such that they are a mixed phase physical material that requires the application of solid handling, liquid handling and gas handling techniques simultaneously without damaging the targeted constituent.

One method of manufacture for the material of this invention is made by producing the industrial hemp as described above. An alumina is dissolved using common sol gel techniques. The sol gel is stabilized in solution by the careful control of temperature of the high viscosity liquid material. Industrial hemp ground and sized to appropriate particle size is added to the sol gel as as can also be the industrial hemp derived steam expanded carbon as also described above to the solution. In this specific embodiment, the industrial hemp is ground and sized to a 30 mesh and the steam expanded industrial hemp derived carbon is ground and sized to 300 mesh. The ratio of industrial hemp, to industrial hemp derived carbon, to the mass of the sol gel mix controls the resulting product enhanced surface area. Industrial hemp derived carbon is usually added in a greater proportion than the larger particle size industrial hemp. In this embodiment the solid particle to liquid ratio was between 40% to 60% by mass. The particle size and the amounts added is dependent upon the desired surface area enhancement of the resulting final material. Since the sol gel is usually hot enough to carbonize the non-carbonized industrial hemp, additional carbonization occurs in situ thus adding to the carbon content of the material but also allowing the particle structure to form. Temperatures of the solution at this point could exceed 400 F. The material is well mixed and then the resulting solution is converted into particles by using many common techniques that allow the solution to precipitate and form as the temperature of the material is reduced. The carbon and industrial hemp is captured in the macro structure of the precipitating aluminum hydroxide. The particles are calcined at a high temperature, the carbon is burned out as is the industrial hemp insitu formed carbon. Calcining temperature exceeds 1200 F.

The calcined particle, now with increased surface area, and with additional sites for industrial hemp functional additive properties is placed in a lithium chloride solution. The LiCl slurry is then mixed with LiOH H2O and is heated and gently stirred. This formation of this lithium specific particle using only alumina is well documented and currently practiced commercially. This invention improves upon this well known method. Once the LiOH H2O industrial hemp carbon slurry is mixed and heated sufficiently, then the slurry is neutralized with a strong mineral, or weak organic acid. Commonly, hydrochloric, acetic or citric acids can be used for this operation. The particle is dried and sized.

The result leaves a particle that is then sized and then packed into various configurations for either fixed bed or moving bed liquid separation equipment. The resulting particle shows a greater capacity and less degradation than its non-industrial hemp counterpart. Capacity of typical alumina sorbent for the removal of lithium from can be in the range of 2 g/liter of sorbent. The attrition of the particles shows an increase in pressure drop from initial 20 psig to upwards of 50 psig after 20 bed volumes of treated material. The specific data depends more so upon the specific arrangement and size of the flow containment equipment. The industrial hemp incorporated equivalent particles show a 20% increase in capacity and a 25% increase in bed volume able to be run versus similar pressure drop.

1. A material, comprising of:
a combination of solid particles, fibers or blocks made from industrial hemp or other cannabis and a substrate material which may or may not be loaded with a functional constituent in a particular process that removes various targeted species from a gas or liquid stream when used at the certain operating conditions.

2. The substrate material of claim 1 being various substrates including but not limited to silica, alumina, zeolite, and carbon

3. The functional constituent of claim 1 being various active constituents including but not limited to halogens, acids, bases, oxidizers, reducing agents, chelators, binders, modifiers, rare earth elements, brines and surfactants

4. The particular process of claim 1 forming the particles, fibers or blocks that include a sequence of steps producing the material that could include mixing, reactions, carbonization, activating and washing at certain temperatures, concentrations, particle sizes and system geometric configurations.
